(19) United States
(12) Patent Application Publication
(10) Pub. No.: US 2011/0107214 A1
(43) Pub. Date: May 5, 2011

(54) TECHNIQUE FOR SYNCHRONIZING AUDIO AND SLIDES IN A PRESENTATION

(75) Inventors: Alexander Kouznetsov, Katy, TX (US); Serguei Nikiforovski, Toronto (CA)

(73) Assignee: SimDesk TECHNOLOGIES, INC., HOUSTON, TX (US)

(21) Appl. No.: 12/047,132

(22) Filed: Mar. 12, 2008

Related U.S. Application Data
(60) Provisional application No. 60/895,254, filed on Mar. 16, 2007.
(60) Provisional application No. 60/896,267, filed on Mar. 21, 2007.

(51) Int. Cl. G06F 3/01

(52) U.S. Cl. 715/716

(57) ABSTRACT

Audio files can be synchronized with a plurality of individual slides, so that a single audio file may be played across multiple individual slides. A user interface is provided which provides a slide timeline and an audio timeline of the entire audio sequence with markers located adjacent the slide timeline indicating particular slides. The user may slide the markers along the slide timeline. The location of the marker is an indication to transition to the indicated slide. As the audio timeline is positioned adjacently and the audio can be played while the slide markers are adjusted, individual slides can be readily synchronized along an audio sequence with little effort.

### CROSS REFERENCE TO RELATED APPLICATIONS

This application claims the benefit under 35 U.S.C. §119(e) of U.S. Provisional Patent Application Ser. Nos. 60/895,254, entitled “Automatic Creation of Credits Page in a Presentation” by Alexander Kouznetsov and Serguei Nikiforovski, filed Mar. 16, 2007 and 60/896,267, entitled “Automatic Creation of Credits Page in a Presentation” by Alexander Kouznetsov and Serguei Nikiforovski, filed Mar. 21, 2007, which are hereby incorporated by reference.

### BACKGROUND OF THE INVENTION

1. Field of the Invention

The present invention relates to synchronizing audio content and slide content in a presentation program.

2. Description of the Related Art

Slide presentations done using computers are commonplace. Today the majority of them are developed using Microsoft PowerPoint. However, PowerPoint has certain limitations which render certain operations difficult, if not impossible, to perform. For example, PowerPoint does not allow audio materials, other than background audio, to be played across multiple individual slides. Audio is inserted as either a background event or as a file embedded in a particular slide in the presentation. As such, it is difficult to handle smooth transitions between slides and audio if that is considered appropriate.

Options have existed for playing a video file across multiple individual slides, graphics or textual information. However, such options required experienced programmers to develop the presentation and required a timeline or time code operations embedded in the video file. This renders it difficult to both develop the presentation and limits the video used to materials with embedded time code operations or flags. As a result, the capability was little used and could not be used on material present only on the Internet which did not contain suitable time code operations.

In this day of the Internet, more and more content in presentations is being provided from various Internet sources. To that end, and based on the general ethical guidelines of use of reference materials and technical writing, it is considered appropriate to provide credit when materials captured from the Internet are utilized in a particular presentation. However, this is extremely difficult to do in a PowerPoint presentation. It effectively requires manually creating a separate slide and populating the content into that slide based on capturing or entering the appropriate credit information. This is a significant amount of work and is therefore not done on a common basis.

User interfaces are important in simplifying operations, including the development of slides in a presentation. Current user interfaces in presentation programs often require frequent access to menu bars and right clicking to change properties. Further, operations on slides, object and the presentation are difficult to perform without extensive use of the menus or right clicking. This renders the user interface somewhat counter-productive in developing the user interface.

It would be desirable to improve the audio operations of presentations, to better provide credit when materials are obtained from various sources and to provide a better user interface to develop the presentation.

### SUMMARY OF THE INVENTION

Embodiments according to the present invention include a mechanism to automatically populate a credit slide when materials are gathered from the Internet. In the preferred embodiment the presentation program is executed as a web-based application running on a server connected to over the Internet. Therefore there is an increased probability that content, particularly images, sound files and the like, will be collected from the Internet and used in a presentation. This is preferably done by using an insert object menu provided by the presentation program. The insert object menu requests the URL of the particular item to be inserted, be it a sound file, an image or the like. When a URL is linked or pasted into the indicated portion of the menu, the program automatically populates a credit entry based on the homepage or web address of a particular content. This field is editable by the user to provide more detailed or appropriate credit if desired. This credit information, as well as the remainder of the link, is maintained as a data element or metadata in the presentation material. When the presentation is interpreted by a player, preferably one that is downloaded from the presentation program website, and then played locally using the Adobe/Macromedia Flash program, the player parses the presentation file provided for its use and automatically captures the credit entries. These credit entries are used to populate an additional slide provided at the end of the presentation by the player. As the presentation is completed the final slide appears, which preferably includes a rolling credit page, so that proper credit is provided for all materials which have been referenced or captured from the Internet. Therefore this is a very simple and automated technique for providing credit and happens automatically without user activity other than the necessary indicating of proper URLs.

Improved audio capabilities in a presentation are provided in preferred embodiments according to the invention. Specifically, in the preferred embodiment, audio files can be synchronized with a plurality of individual slides, so that a single audio file may be played across multiple individual slides. In a convenient fashion the slides are synchronized to the audio content. In the preferred embodiment a user interface is provided which provides a slide timeline and an audio timeline of the entire audio sequence with markers located adjacent the slide timeline indicating particular slides. The user may manipulate and slide the markers along the slide timeline. The location of the marker along the slide timeline is an indication to transition to the indicated slide. As the audio timeline is positioned adjacently and the audio can be played while the slide markers are adjusted, individual slides can be readily synchronized along an audio sequence with little effort. In addition, this is done without adding time code operations to the audio file and without requiring extensive programming capabilities of the user or the downloading of large files when playback is desired. Embodiments according to this invention thus provide improved audio tools by allowing multiple slides to be played during and in synchronization with a single audio file.

An improved yet simple presentation development user interface is provided in preferred embodiments. The development user interface includes a slide selection tab area having two sizes of tabs to allow easier navigation of longer presentations, an operations focus area to allow operations on individual objects, individual slides or the entire presentation, and an object addition menu. These are provided in addition to conventional menu and tool bars and aid in the quick and easy development of a presentation.

### BRIEF DESCRIPTION OF THE FIGURES

FIG. 1 is a general block diagram of various computers and end user devices according to the present invention.

FIG. 2 is a block diagram indicating various software modules and files present in the presentation server of FIG. 1.

FIG. 3 is block diagram indicating the various software modules and files present in the end user devices of FIG. 1.

FIGS. 4-14 are screen shots of the development of a presentation according to the preferred embodiment.

FIGS. 15-17 are enlarged screen shots of an audio and slide synchronization interface according to the present invention.

FIGS. 17A-17C are screen shots of the layout of the development user interface according to the preferred embodiment.

FIGS. 18-25 are screen shots of the actual presentation of FIGS. 4-14, with FIGS. 23 and 24 illustrating a credit slide according to the present invention.

### DETAILED DESCRIPTION OF THE PREFERRED EMBODIMENT

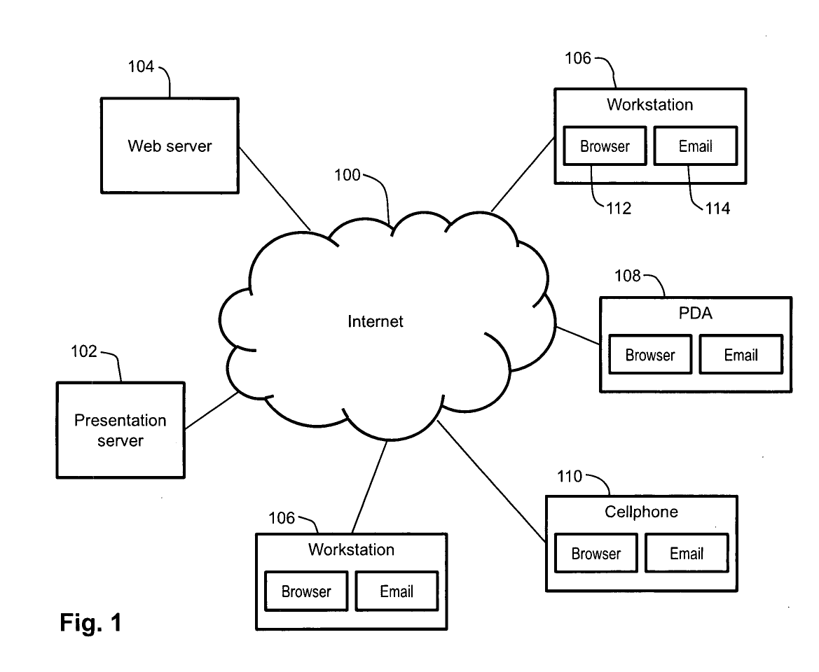

Referring now to FIG. 1, the general environment of the preferred embodiment is illustrated. In the preferred embodiment, operations occur using a web based environment. Internet 100 forms an interconnecting network between the various servers and end user devices. A presentation server 102 is connected to the Internet 100 to operate the presentation program according to the preferred embodiment. A general web server 104 is illustrative of various other web servers where content can be obtained or referenced. A series of computer workstations 106 are connected to the Internet and thus have communication with both the presentation server 102 and the web server 104. In addition, a PDA 108 is connected to the Internet 100, usually in a wireless environment, as is a cell phone 110. The workstations 106, PDA 108 and cell phones 110 are exemplary end user devices and all generally include browser software for browsing the Internet and email software for receiving emails. In the preferred embodiment presentations are provided from the presentation server 102 to a particular end user device either as a text HTML file or as an HTML file sent as an attachment to an email.

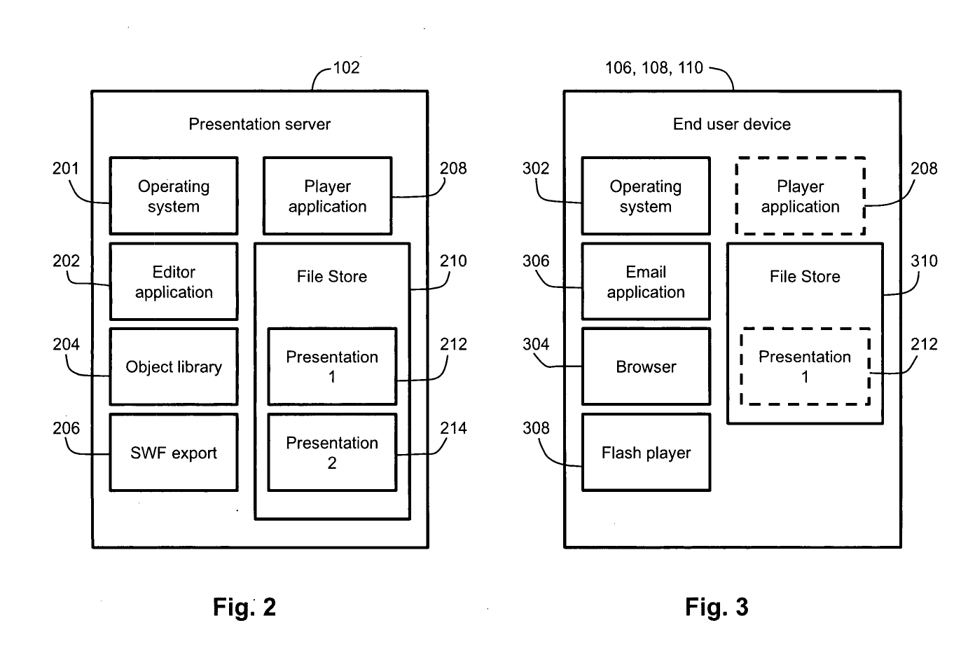

FIG. 2 provides details of the various modules and files present on the preferred embodiment of the presentation server 102 according to the present invention. An operating system 101 is included, such as Linux or Microsoft Windows Server. A first software module is the editor application 202 for the presentation. The editor application 202 is a web server-based program to allow presentations to be developed using conventional web browsers. Also contained on the presentation server 102 is an object library 204 of stock images, formatting tools and the like.

Further, as the preferred mode of display of the presentation is as an Adobe/Macromedia Flash movie, it is considered appropriate to be able to export from a Flash file format to more conventional file formats and this functionality is provided by an SWF export program 206 which produces a single SWF file compiled from the presentation. In the preferred embodiment the clip art files are kept as separate movie files (SWF). To compile the single SWF file for presentation, for each single SWF object used in the presentation, it is “decompiled” from the individual SWF file, all internal variables and movie parameters are retrieved, and then this new object is added to the new SWF of the presentation.

Also present on the presentation server 102 is a player 208 which is downloaded to the particular end user device 106, 108 or 110 to provide interpretation capabilities from the HTML file which is developed by the editor application 202 and is provided from the presentation server 102 to the particular end user device 106, 108, 100. The player 208 interprets the HTML file and provides text, images and the like to a Flash player in the end user devices.

The presentation server 102 preferably contains a file store area 210 which contains a plurality of presentations 212 and 214 as examples. According to other embodiments, the presentations can be stored at other locations such as another shared server or on the particular end user devices but for efficiency of editing using the editor application 202 it has been found to be better to use a file store 210 resident on the presentation server 102.

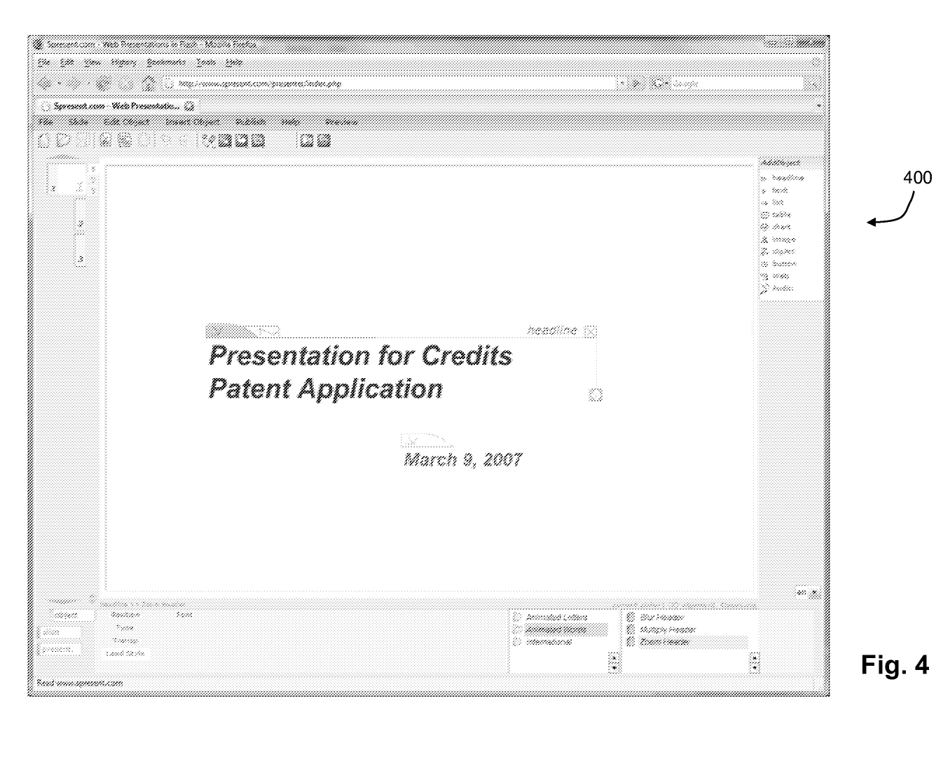

FIG. 3 provides a block diagram of the various software modules that are present on a workstation 106, a PDA 108 or a cell phone 110. An operating system 302 is present, as are a browser program 304 and an email program 306. In addition, a Flash player 308 is present. As stated above, the preferred embodiment utilizes Flash files and operations to simplify the presentation and reduce its size. In addition, in dotted lines is the player 208 which is downloaded from the presentation server 102 when a particular file needs to be accessed and played. As above, the player 208 translates between the actual presentation format, which is an HTML format in the preferred embodiment, and the Flash format utilized by the Flash player 308. Also shown in dotted lines is a presentation 212, in a file store 310, which has been downloaded from the presentation server 102 and is to be played on the end user device.

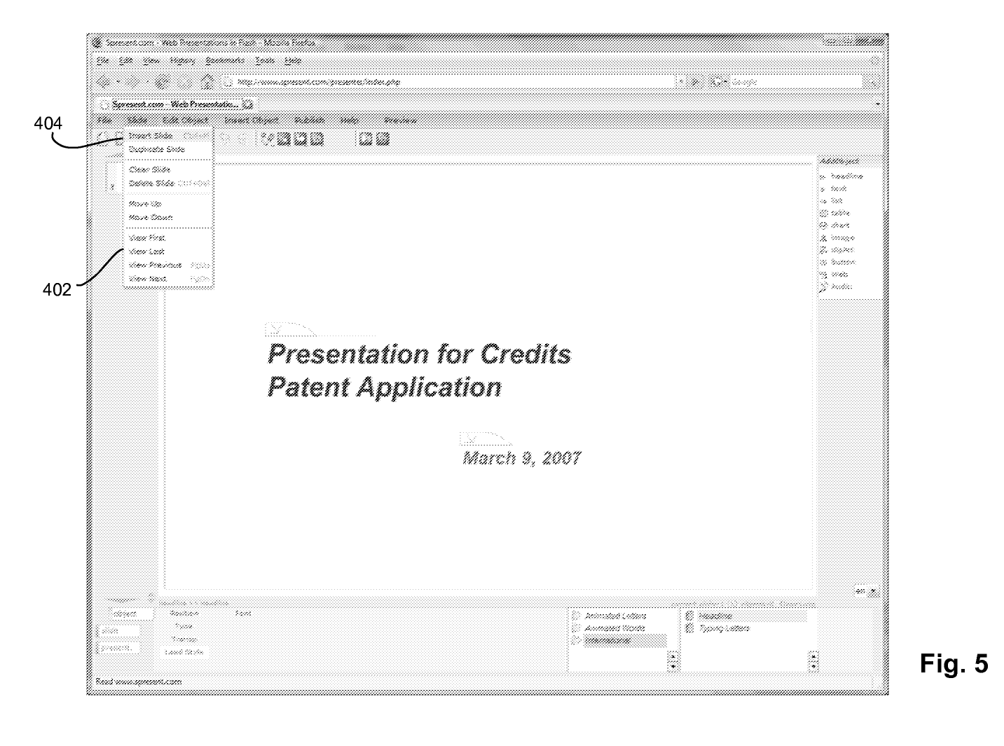

Referring to FIG. 4, a first screen shot of a title page of a presentation is illustrated. The title page 400 is a simple title page. As can be seen, the presentation development software runs in a browser window as the editor application 202 is present on the presentation server 102 and accessed from the end user device, generally a workstation 106 for presentation development, over the Internet 100.

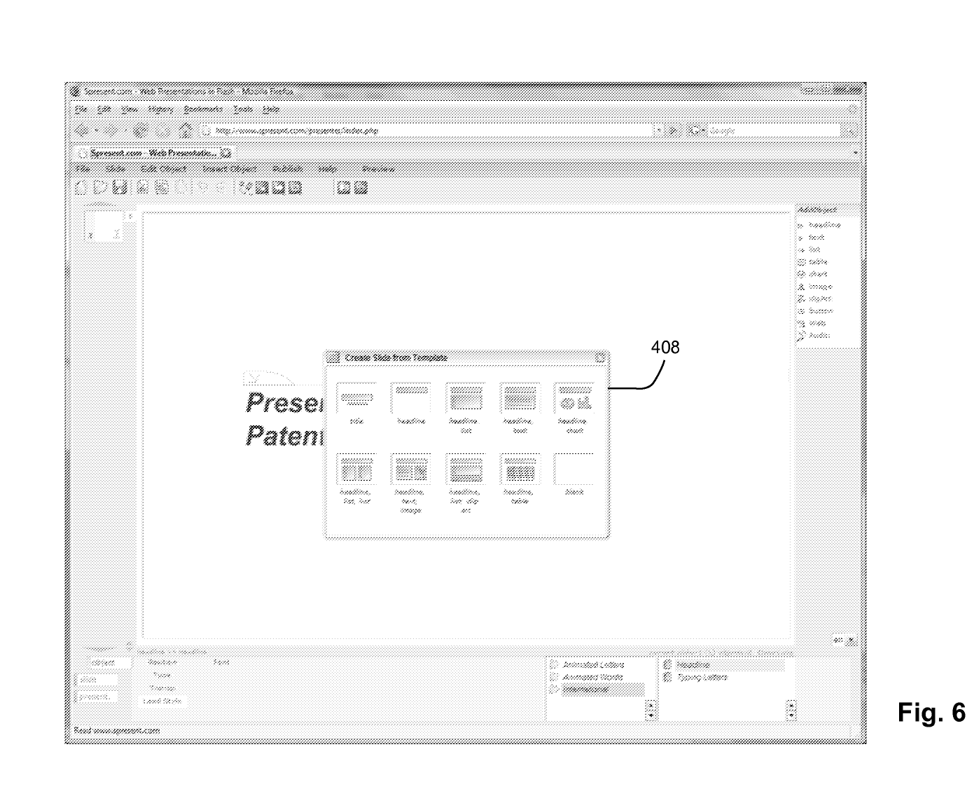

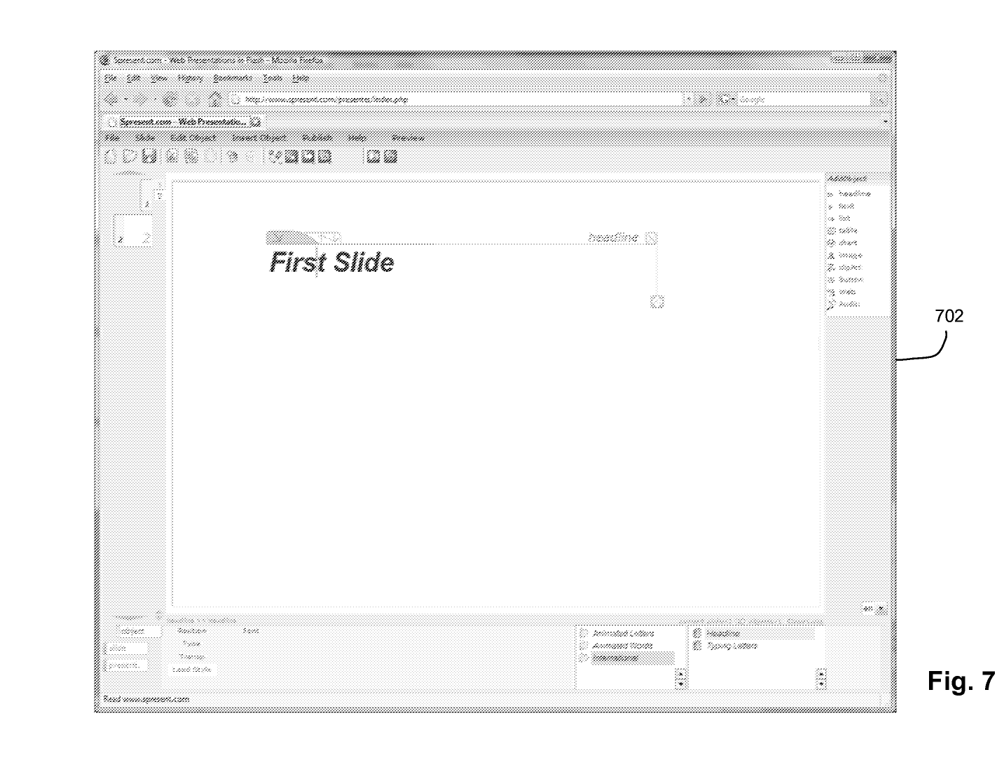

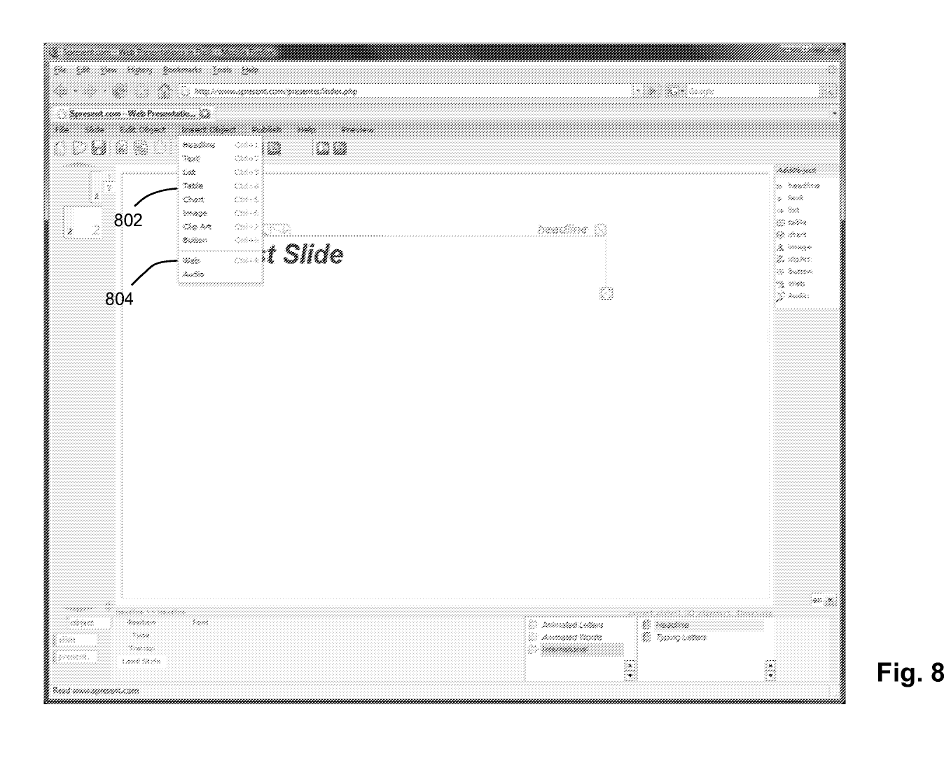

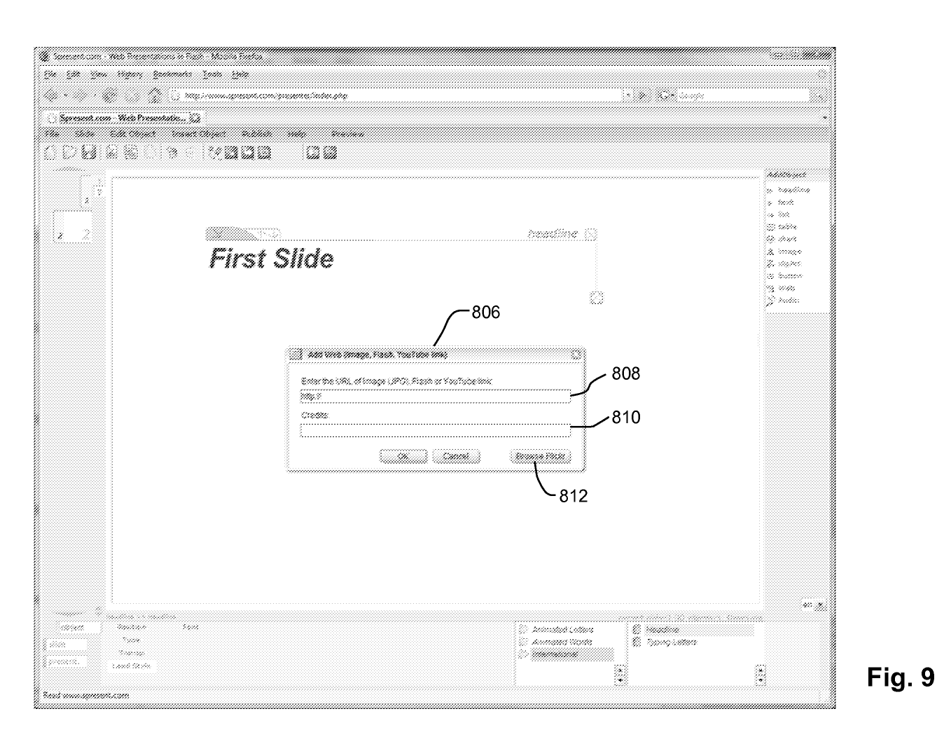

FIG. 5 illustrates the development of a new slide according to the preferred embodiment. A drop-down box 402 is presented by clicking on the slide heading. An insert slide entry 404 is highlighted and then clicked and a new slide template menu 408 as shown in FIG. 6 is presented. The new slide template menu 408 illustrates the potential formats of the slide. In the illustrated embodiment, a headline template was utilized so that the new headline slide 702 appears in FIG. 7. The word headline, which automatically appears, has been edited in the illustration of FIG. 7 to indicate a First Slide heading. With this First Slide heading completed, it is appropriate to add an object and referring to FIG. 8 a drop-down menu 802 of the insert object heading is provided. In the illustrated embodiment it is desired to add materials available over the Internet 100 so the web entry 804 is selected.

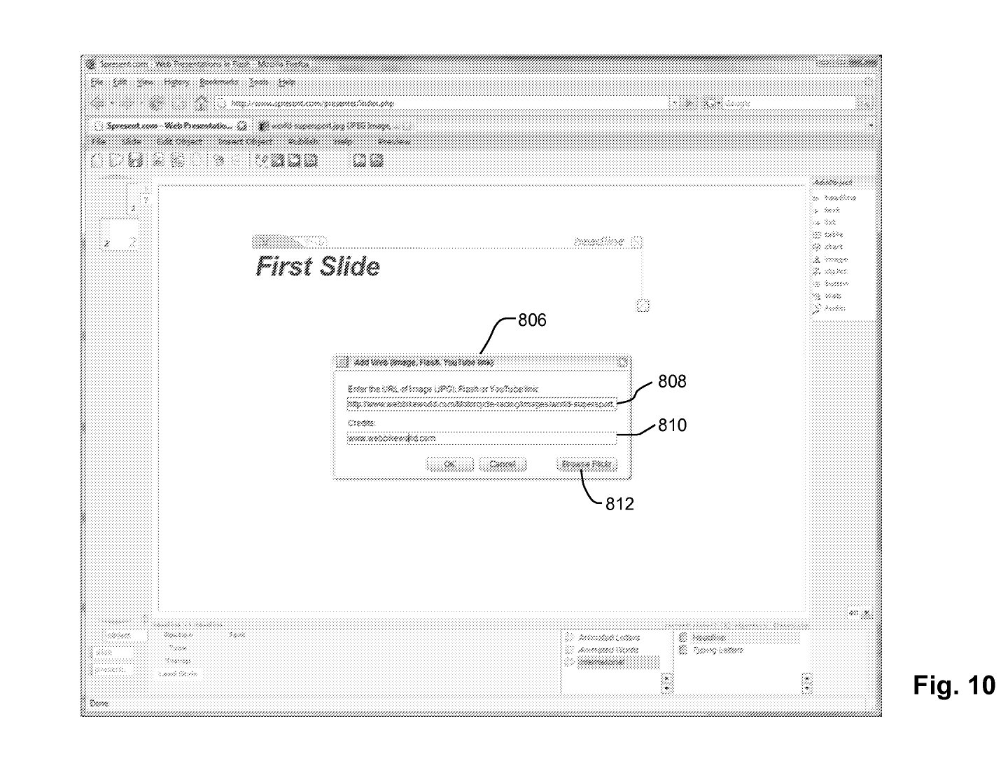

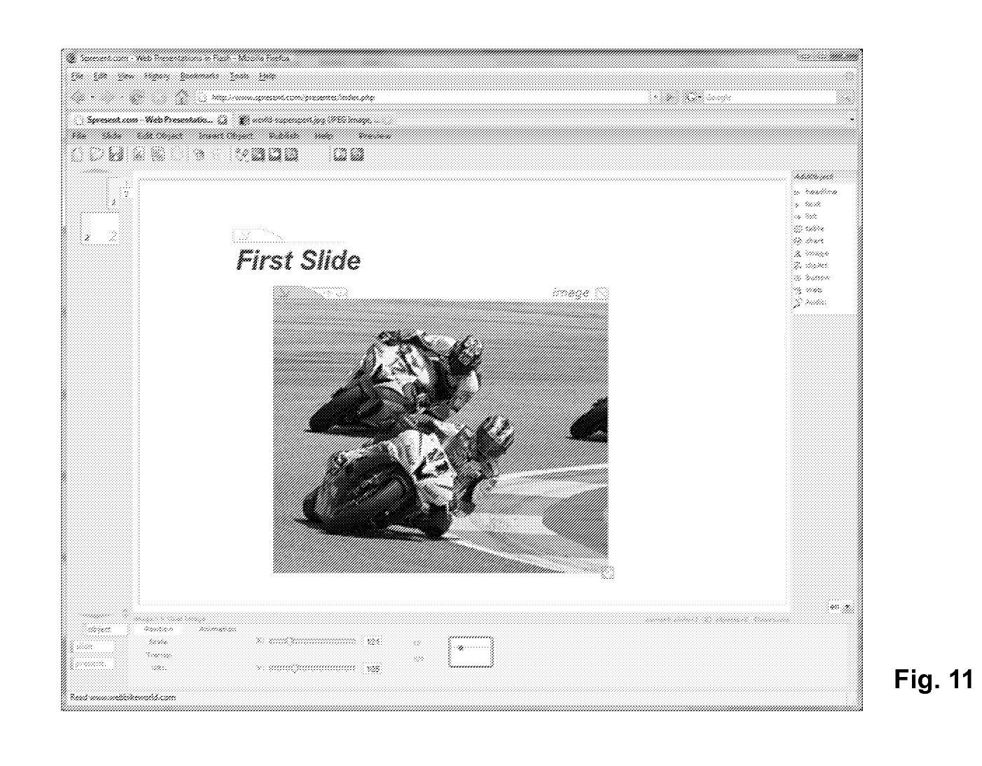

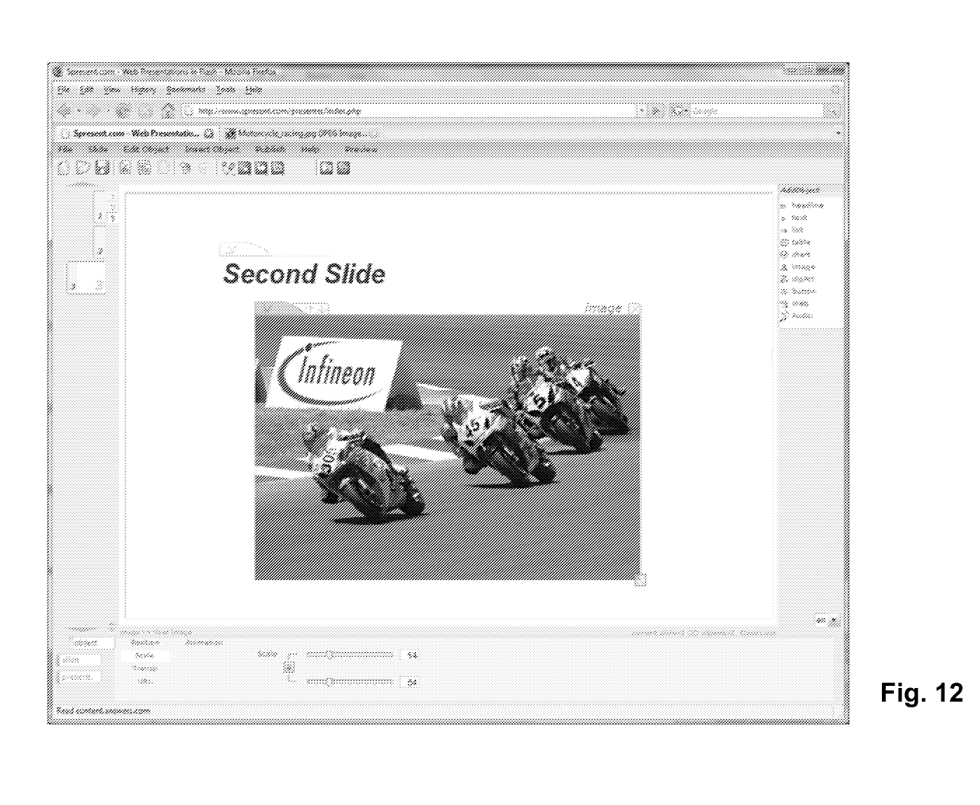

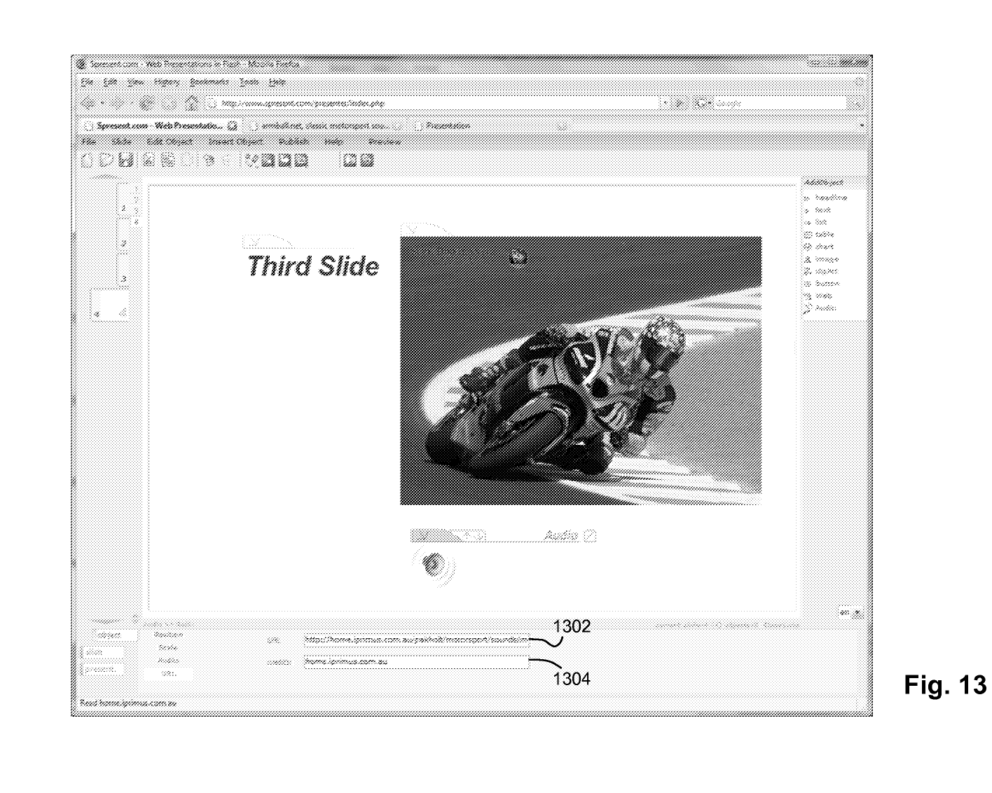

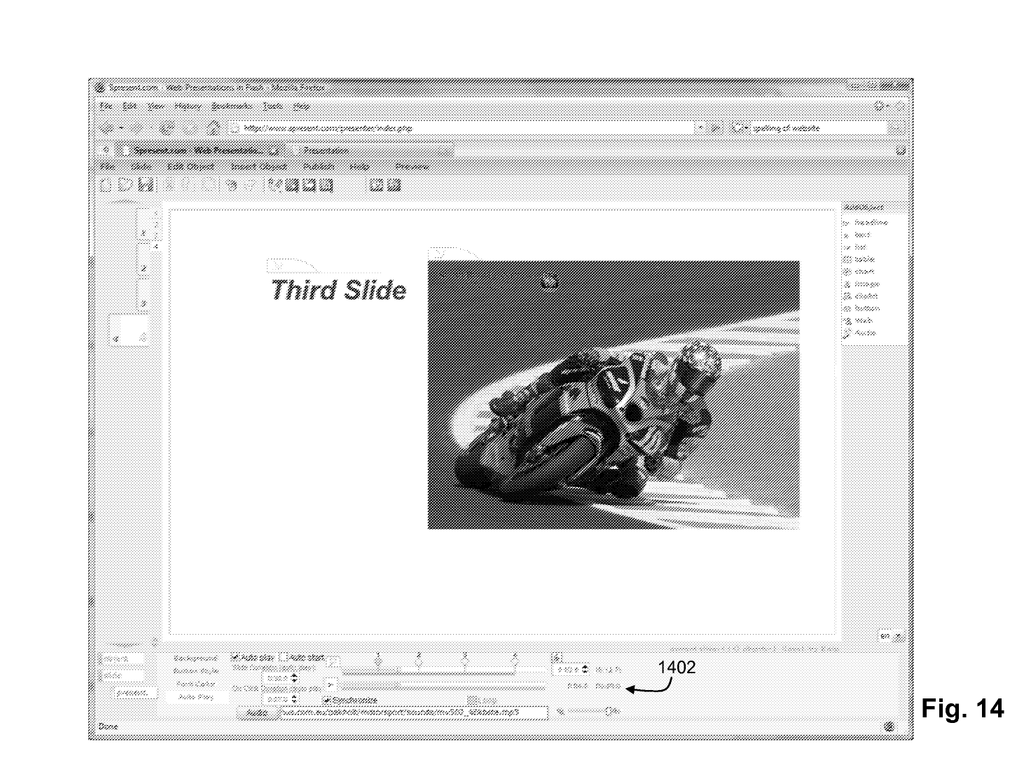

Upon clicking of the web entry 804, a dialog box 806 as shown on FIG. 9 appears. This dialog box 806 is requesting the entry of a URL 808 for an image such as a JPEG, a Flash presentation or a video file. Referring then to FIG. 10, a URL of http://www.webbikeworld.com/motorcycle-racing/images/world-supersport.jpg has been inserted. As can be seen there is an entry in the credits section 810 which indicates http://www.webbikeworld.com. This has been automatically generated by the editor application 202 running on the presentation server 102. In this case it is a simple image with no tags or other known information associated with the particular image, so the editor application 202 simply inserts the home page of the particular website. As can be seen, the dialog box 806 includes a button 812 that says Browse Flickr. Flickr.com is a common image or picture service on the Internet. In the preferred embodiment, a dedicated interface to Flickr.com is provided so that Flickr images can be more readily inserted into the presentation. One advantage of a Flickr image is that the captions or other headings and information associated with the photo that are saved on the Flickr.com website are automatically populated into the credits entry 810 instead of simply the home page of the website. In the alternative, the user can enter the desired credit info to be associated with the image. FIG. 11 shows the First Slide after the indicated image has been loaded into the presentation for viewing during editing operations. Proceeding to FIG. 12, a Second Slide, developed in like manner as the First Slide, is illustrated. FIG. 13 is a similarly developed slide except that it also includes an audio file as shown. The URL and credits for the audio file, http://home.iprimus.com.au/pakholt/motorsport/sounds/mv500_{—}48kbste.mp3 and home.iprimus.com.au, respectively, are shown in blocks 1302 and 1304 below the image and as above the credit has automatically been populated from the home page address for the particular website.

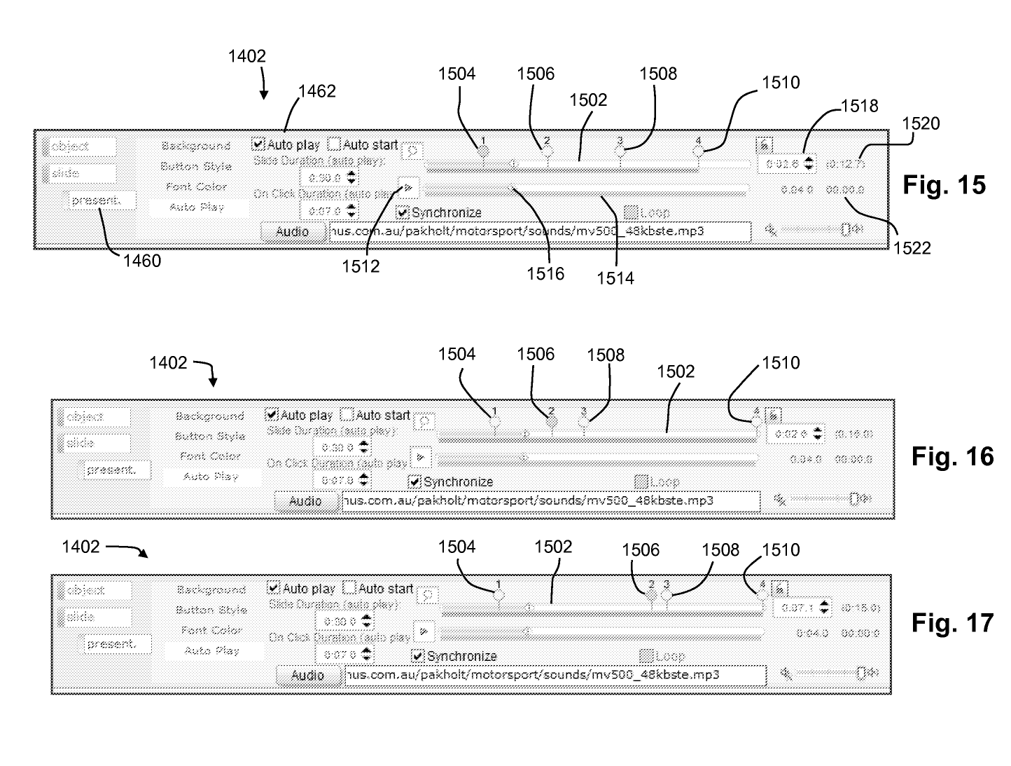

Proceeding then to FIG. 14, as an audio file has been included in the presentation, it is appropriate to determine the relationship of the audio file to particular slides in the presentation. In embodiments according to the preferred embodiment, the relationship between the slides and the audio file can be varied as desired by the user. As indicated above, in the prior art audio files were either played entirely in background mode and completely unsynchronized to the particular slides or were played only during the particular slide presentation. In the preferred embodiment slides can be introduced at any time along an audio file and indeed can start before and end after the audio file. To simplify this operation a user interface 1402 is illustrated in FIG. 14.

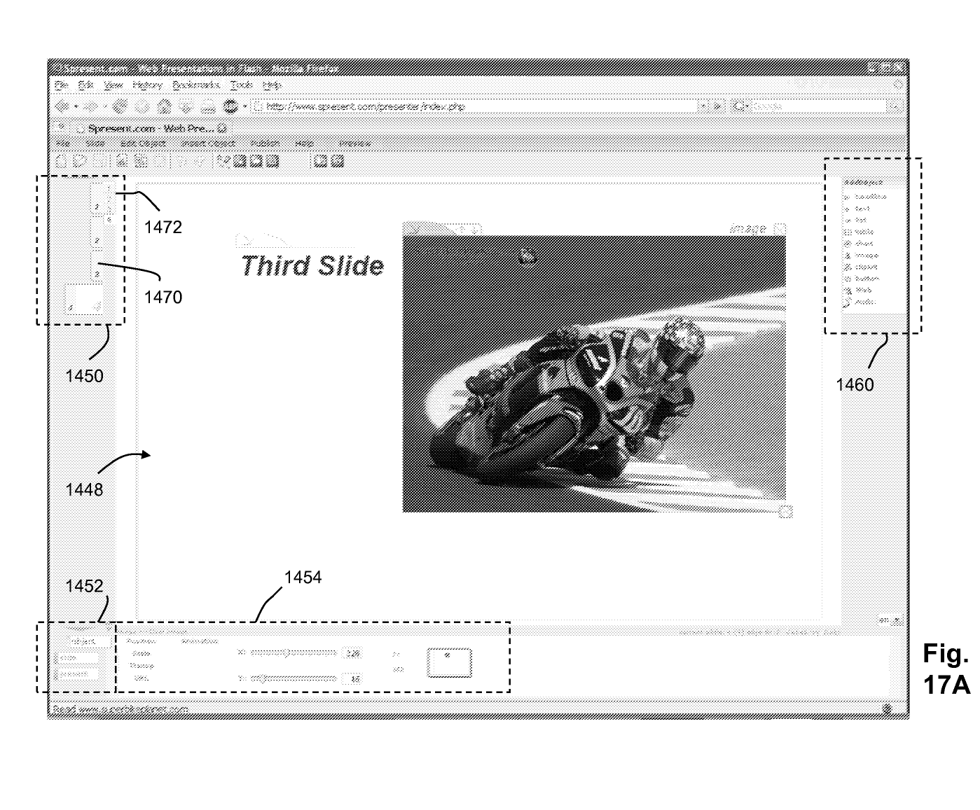

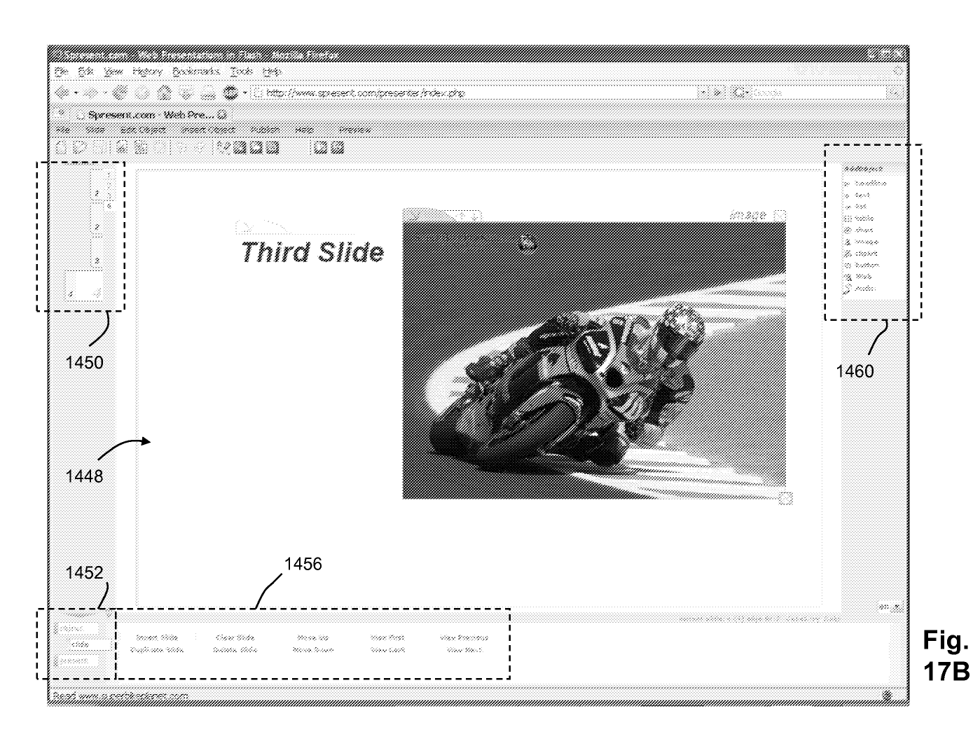

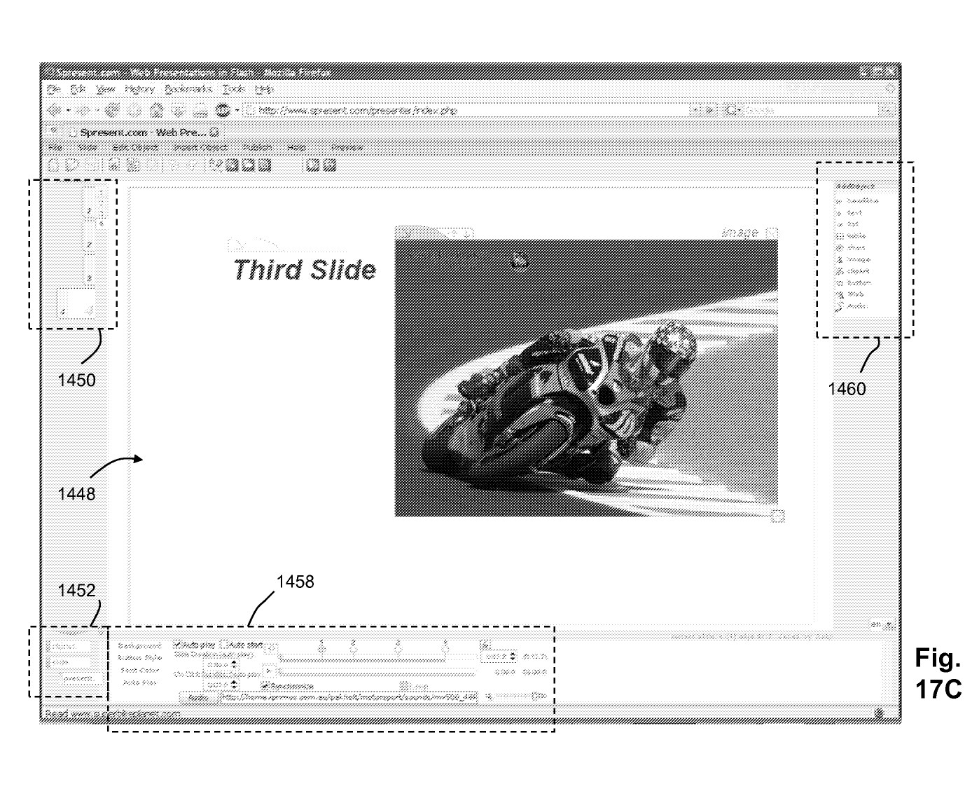

The user interface 1402 is illustrated in more details in FIGS. 15-17. In the preferred embodiment, when presentation mode 1460 is selected and a play emblem 1462 is checked, the user can synchronize the particular slides to the audio materials. As can be seen, the audio materials or files are provided as an audio timeline 1514, with a slide timeline 1502. There are a series of pins or markers 1504, 1506, 1508 and 1510 provided along the slide timeline 1502. Each of these represents an individual slide in the presentation. In the view of FIG. 15, the slides are effectively evenly placed along the slide timeline 1502. In FIG. 16, as can be seen the user has dragged various of the markers 1506 and 1508 along the slide timeline 1502 to allow better synchronization with the actual content of the audio as desired. FIG. 17 illustrates yet another variation where the audio actually commences prior to the commencement of the first slide 1504, there is a very long period for slide two 1506 and then slide three 1508 occurs shortly thereafter followed by conclusion with slide four 1510. Thus this user interface with an illustrated slide timeline 1502 with markers 1504-1510 indicating particular slides allows the user to very easily and very simply synchronize a particular slide with the audio content present in the presentation.

To aid in the synchronization, the total time of the slides is shown as time 1520, with the total time of the audio file shown as time 1522. If the two times are equal, the audio play and the slide presentation will start and end simultaneously. By varying the amounts, quiet time before the beginning slide or slides or after the ending slide or slides can be developed. Alternatively, the audio can commence before and end after the slides.

In the preferred embodiment the user can hit a play button 1512 which will start the audio playing. In the preferred embodiment a marker 1516 moves along both the slide timeline 1502 and the audio timeline 1514 to indicate progress of the audio throughout the entire audio clip. Then as the user is listening to the particular audio materials, the appropriate slide marker 1504-1510 can be positioned to be fully synchronized with the audio. Thus, the user listens to the audio real time and moves the markers around as desired. In an alternative embodiment the user can time the audio segment using a stopwatch or other timer to determine the actual time desired for a slide presentation and that can be entered in manually in a data entry box 1518 for the highlighted marker 1504-1510. Therefore this provides for a very simple and easy way to synchronize slides to audio.

While the preferred embodiment utilizes only a single audio file, in alternate embodiments multiple audio files can be used, with the various files concatenated on the audio timeline 1514. In further variations, the individual audio clips can be moved along the audio timeline 1514 to provide gaps, if desired.

FIGS. 17A to 17C illustrate the layout of the development user interface. A conventional menu bar and tool bar with selected buttons or icons is provided at the top of the screen. A working area 1448 is provided as the main area and is centered. To the upper left of the working area 1448 is a slide selection area 1450. This slide selection area 1450 includes large slide tabs 1470, which operate similar to conventional tabs for selecting pages, and small slide tabs 1472. The large slide tabs 1470 provide convenient access to desired slides, with the extended tab clearly and quickly showing the slide being worked on. Due to their large size, as the presentation grows in length, the large slide tabs quickly scroll off the screen and a scroll mechanism would have to be used. This problem is alleviated by the use of the small slide tabs 1472. Because they are much smaller, a much higher number of the small slide tabs 1472 will be present at any given time, in most cases easily handling all of the slides of the presentation. Thus they simplify navigation in longer presentations.

Below the working area 1448 is an operations focus selection area 1452. As seen, there are three options in the preferred embodiment, object, slide and presentation. The result of selection is each option is shown in FIGS. 17A-17C in order. In the object case of FIG. 17A, an object properties area 1454 is provided, allowing quick control of the selected object. The actual property fields change depending on the particular type of object that is selected. In the slide case of FIG. 17B, a slide options area 1456 is provided, allowing quick slide level operations. In the presentation case of FIG. 17C, a presentation option area 1456 is provided. In the illustrated case the Auto Play selection is shown for slide and audio synchronization. Other options, such as background, button style and font color can also be selected, with relevant areas appearing, as those are common presentation-wide items. The operations focus area 1452 and resulting properties or options areas provide quick access for changing presentation elements at multiple levels from a single place.

To the right of the working area 1448 is an objects menu 1460 to allow quick selection of objects to be added to the active slide.

This development user interface allows rapid development of a slide presentation, in the navigation of slides, the addition of object and in the operations on objects, slides or the presentation as a whole.

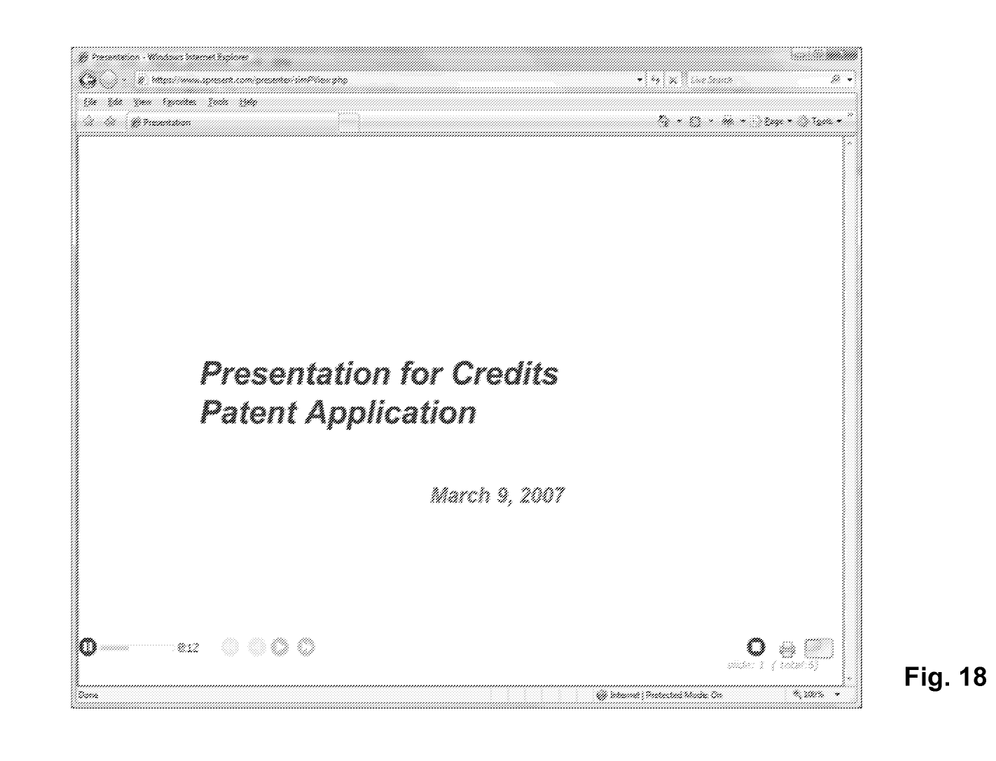

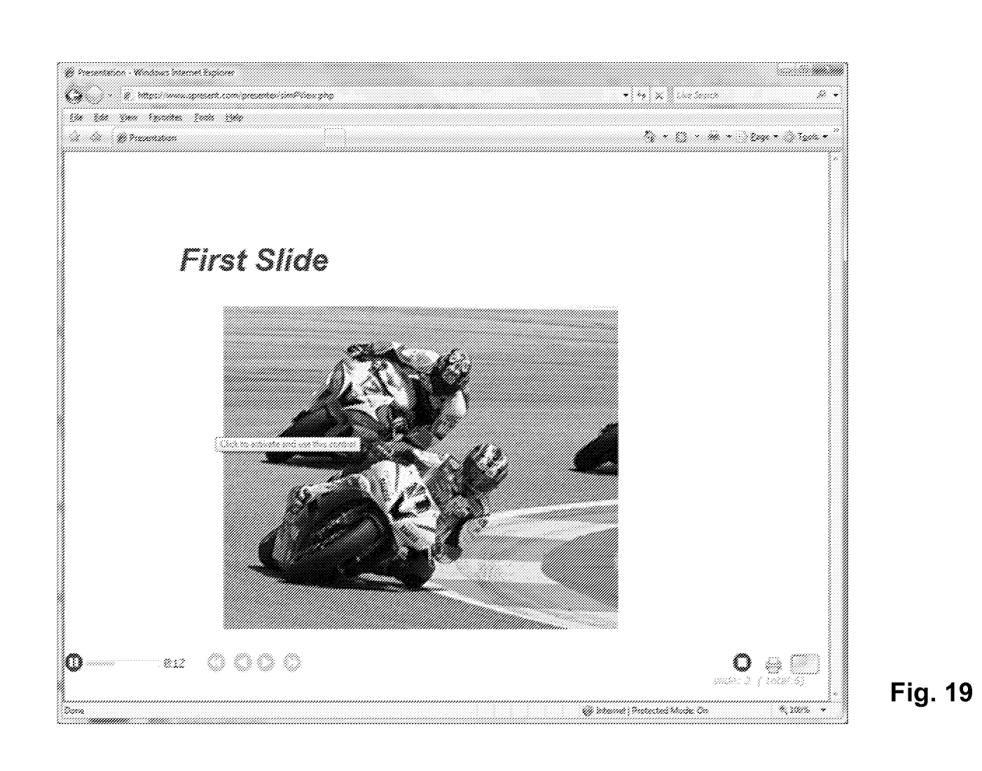

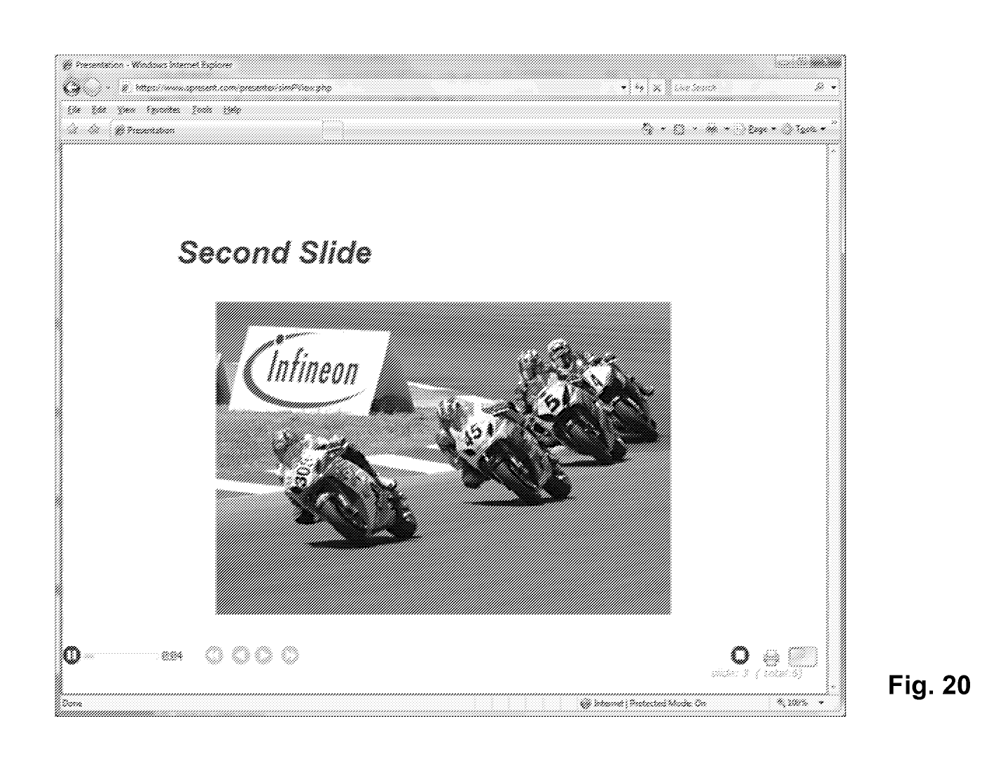

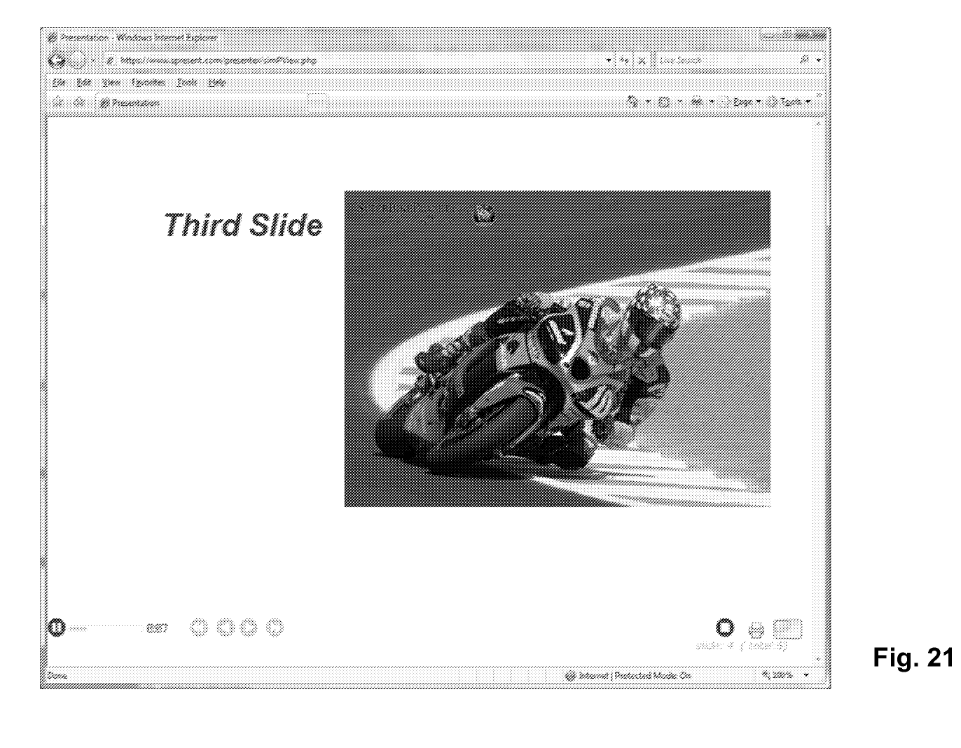

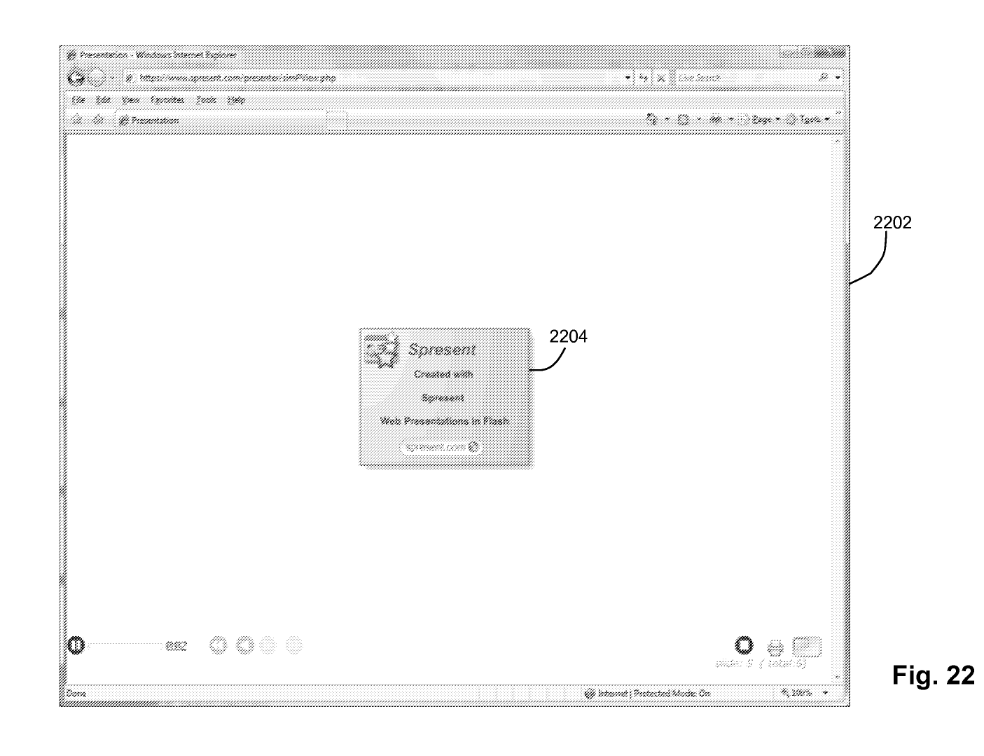

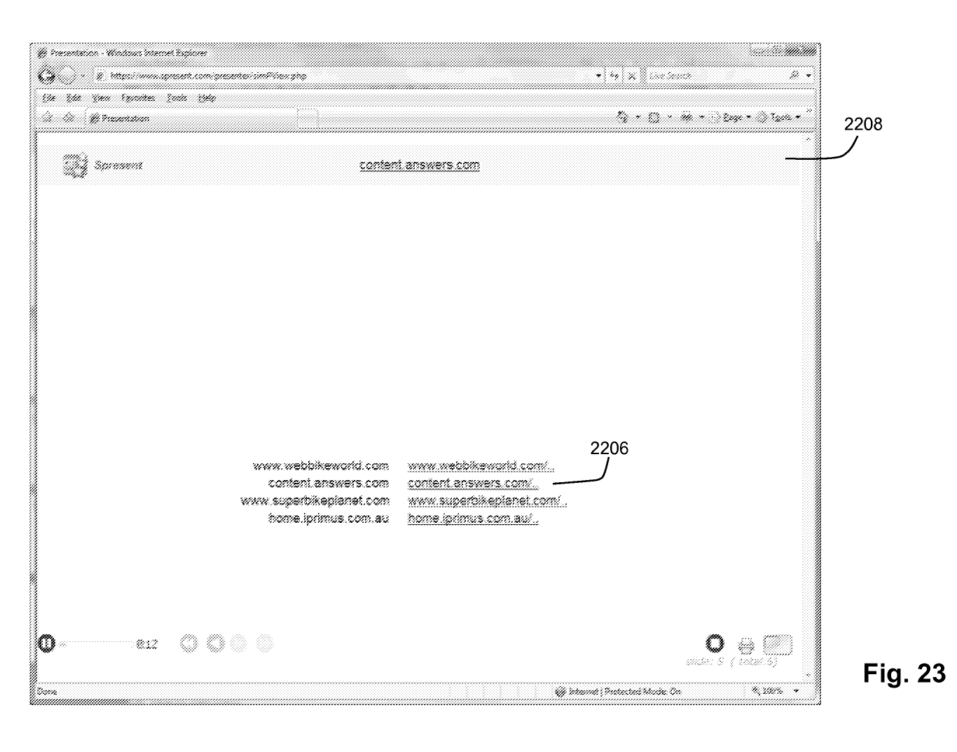

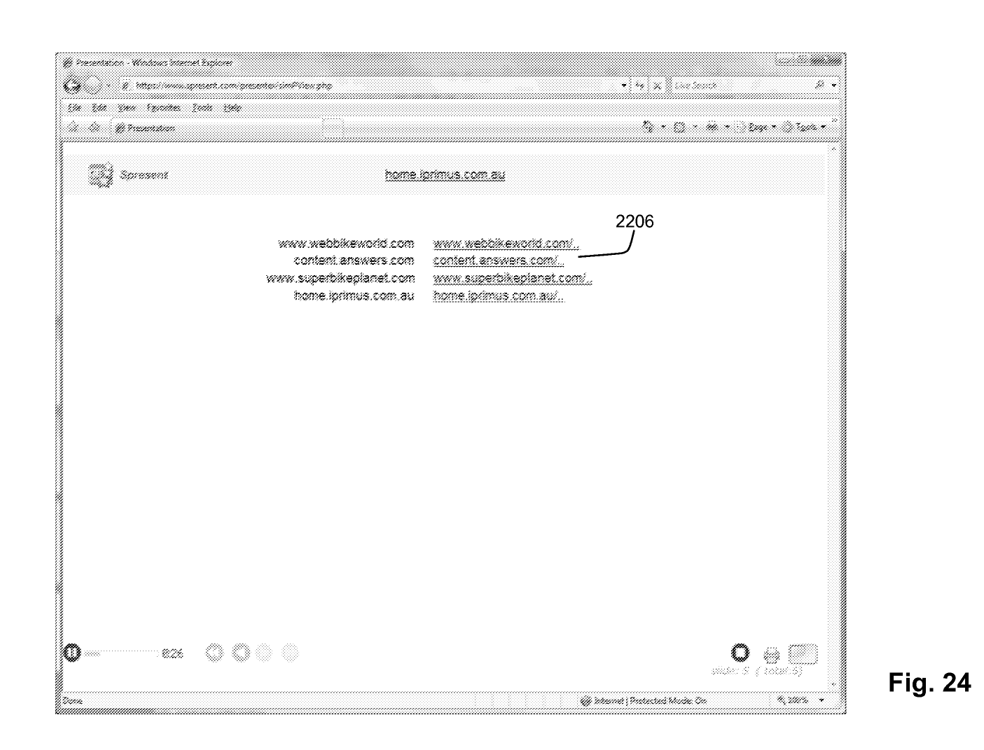

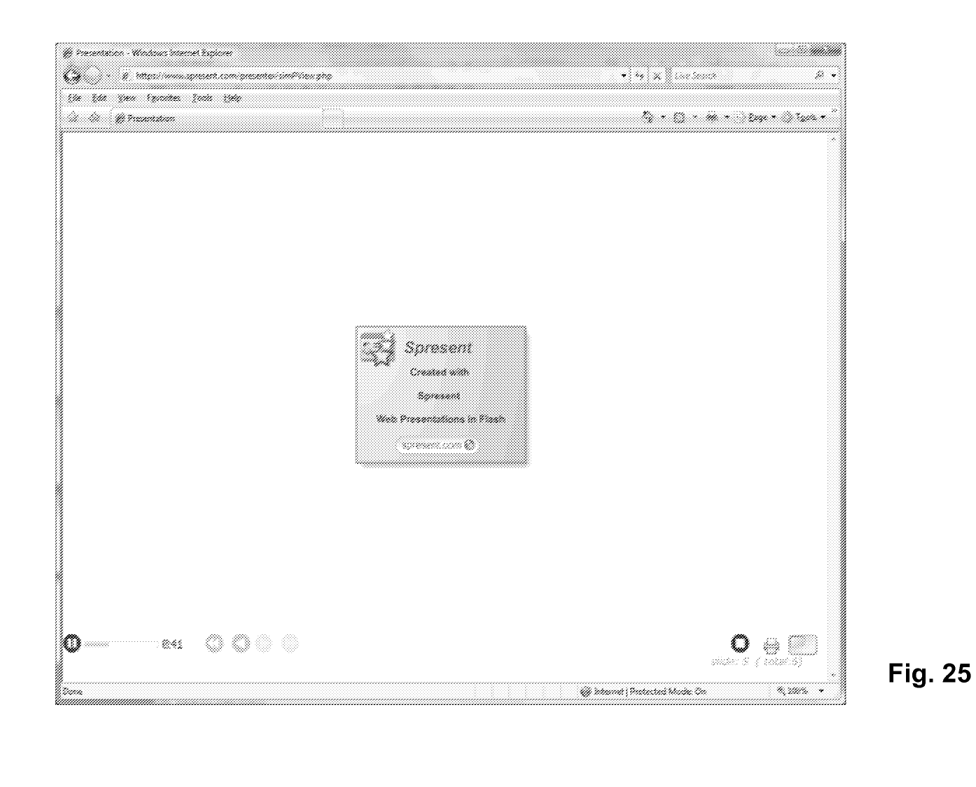

FIGS. 18 to 21 indicate the playback or actual presentation of the presentation which has been developed in the prior slides. After the completion of the final slide developed by the user as shown in FIG. 21, the player 208 of the preferred embodiment presents a concluding slide shown in FIG. 22. In the illustrated embodiment the concluding slide 2202 includes a splash screen icon 2204 to provide advertising for the program itself. Then, as shown in FIGS. 23 and 24, the various credits 2206 which have been accumulated from the various slides as discussed above are scrolled. These credits are automatically collected by the editor 202 during the development of the presentation as described above. They are then provided in the file which is downloaded to form the presentation. In the illustrated embodiment of FIGS. 23 and 24, the credits have scrolled up and off the page and after the credits have scrolled the splash icon again appears on FIG. 25. When the credits scroll begins, a new heading area 2208 is displayed. In this area, various advertisements or linked company logos can be provided to provide revenue from the presentation. In the preferred embodiment, the player 208 can inspect a database (not shown) to determine if one of the websites displayed in the credits has contracted to be displayed in the advertising area. If so, the desired ad or logo is presented and the fee is charged. If none of the credit websites have contracted, general ads or linked logos can be displayed as well known to those skilled in the art.

The HTML file of the illustrated presentation is shown in Appendix A. As can be seen, it is a simple HTML file which is downloaded from the presentation server 102 and executed by a standard browser in the end user device 106, 108, 110. The presentation itself is done using a JavaScript function which is titled as SubmitForm. Each of the particular slides and other actions are indicated as a portion of a long text entry. Basically, the long text entry is a string of information about the presentation as a whole, each slide and the items relevant to each slide. For example, the string starts by defining the dimensions of the presentation (width=580&height=370), the numbers of slides (sn=4) and the like. A file for a set of buttons (url=./Objects/Buttons/Button Sets/Circle Set.swf) is indicated. As seen, the buttons are provided in a Flash file format. In the line starting with “_text[1]”, the “audio-sync=true” parameter is set, indicating synchronized audio and slides. Just after that is an indication of the slide 1 duration: “s1_{—}0_duration=3214”. This starts the information on the opening slide and indicates the amount of time from the beginning of the presentation that slide 1 is displayed. In the “_text[4]” entry is “s2_{—}0_duration=2427”. This is the duration of the second slide. Proceeding down to the line starting with “_text[5]”, the URL of the first image is seen. In “_text[6]” is the entry “s2_{—}2_credits=www.webbikeworld.com”. This is the first credit entry. As discussed above, this is placed by the editor application 202 automatically. Following this is “s3_{—}0_duration=3427” to indicate the duration of the third slide. The “_text[8]” includes “s4_{—}0_duration=3661”, the duration of the fourth slide, the last slide before the credit slide.

At the end of the HTML code is an action which is the operation of the routine SubmitForm. This action downloads the player 208 from the presentation server 102. When the player 208 is downloaded from the presentation server 102, the player 208 then parses the text string provided in the array that provides the presentation and slide information. The player 208 parses the string and then appropriately converts the commands and data and provides data and control operations to the Flash player 308 present in the end user device. In this manner the actual presentation can be kept extremely small for fast and efficient operation over the Internet. As can be seen, each of the actual selected images and/or audio or video clips is actually loaded live from the Internet and not stored with the actual presentation, thus further shrinking the presentation.

In the preferred embodiment, for synchronized audio file and slide presentation, unlike in the prior act, no embedded operations in the audio files are required and the downloaded information for timing is extremely small, just the slide duration text strings. The player 208 does not edit the retrieved audio file but instead uses any time codes in the audio file in conjunction with the slide duration times to provide the synchronization. This technique minimizes the length of the presentation HTML files while allowing multiple slide audio without editing the audio file.

While in the preferred embodiments the actual object is not embedded in the HTML file provided as the presentation, in alternate embodiments the actual object, such as a photo, can be embedded in the file and only the credit information need be included in the presentation file. While the preferred embodiment presents the credits as a scrolling list on a final slide, other possibilities are available, such as a fixed list, inclusion as a footnote on the relevant slide and the like.

While the preferred embodiment illustrates the slide and audio timelines as horizontal and linear, they can be concentric arcs, angled lines and the like. While the slide markers are shown as pins in the preferred embodiment, many other shapes can be used which allow individual selection of the slides and easy movement of the markers. While the preferred embodiment shows the slide and audio timelines as the same length and then the time scale factor is used to make the timelines easier to use, in other embodiments the timelines can be different lengths and use a fixed time scale factor. This would allow a shorter audio file to be easily positioned in relation to the slide timeline if only a portion of the slides are related to the audio or a shorter slide presentation to be easily positioned with respect to a longer audio file. While the preferred embodiment shows moving a slide marker to adjust its location on the slide timeline while the audio file is playing, a button could be provided to automatically place the next slide on the slide timeline when depressed. In that manner the user need only listen to the audio and keep operating the button for each slide transition. While the preferred embodiment shows the synchronization user interface and a fixed slide, selecting a particular slide marker could bring up the related slide to better allow the user to confirm that the slide relationship to the audio is correct.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

APPENDIX A
<html>
<head>
<meta http-equiv=“Content-Type” content=“text/html; charset=utf-8”>
<title>Presentation Case1 try 2.sip</title>
<script type=“text/javascript”>
<!—
function submitForm ( )
{
_text= new Array( );
_text[0]=“isEmbed=false&version=3.4.0.04
web&width=580&height=370&sn=4&comment=&background_type=sDir&background_url=&button_{—}
type=sDir&button_url=./Objects/Buttons/Button Sets/Circle
Set.swf&autoPlay=true&autoStart=true&pageDuration=30000&onClickDuration=7000&buttonD”;
_text[1]=“irect=&fontcolor=&audio_type=wDir&audio_url=http://home.iprimus.com.au/pakholt/motor
sport/sounds/mv500_48kbste.mp3&audio_volume=100&audio_loop=false&audio_sync=true&on1=
2&s1_0_duration=3214&s1_1_oType=headline&s1_1_type=sDir&s1_1_url=./Objects/Headlines/An
”;
_text[2]=“imated Words/Zoom
Header.swf&s1_1_xPos=90&s1_1_yPos=150&s1_1_xscale=100&s1_1_yscale=100&s1_1_width=
350&s1_1_height=50&s1_1_depth=1&s1_1_text=Presentation for Credits Patent
Application&s1_1_font=Arial&s1_1_fsize=24&s1_1_fcolor=3355443&s1_1_alpha=100&s1_2_o”;
_text[3]=“Type=headline&s1_2_type=sDir&s1_2_url=./Objects/Headlines/International/Headline.sw
f&s1_2_xPos=265&s1_2_yPos=245&s1_2_xscale=100&s1_2_yscale=100&s1_2_width=200&s1_2
_height=80&s1_2_depth=2&s1_2_text=March9,
2007&s1_2_font=Arial&s1_2_fsize=16&s1_2_fcolor=67”;
_text[4]=“10886&s1_2_alpha=100&on2=2&s2_0_duration=2427&s2_1_oType=headline&s2_1_typ
e=sDir&s2_1_url=./Objects/Headlines/International/Headline.swf&s2_1_xPos=85&s2_1_yPos=55&
s2_1_xscale=100&s2_1_yscale=100&s2_1_width=350&s2_1_height=50&s2_1_depth=1&s2_1_tex
t=First Sl”;
_text[5]=“ide&s2_1_font=Arial&s2_1 _fsize=24&s2_1_fcolor=3355443&s2_1_alpha=100&s2_2_oTy
pe=image&s2_2_name=User
Image&s2_2_type=wDir&s2_2_url=http://www.webbikeworld.com/Motorcycle-racing/images/world-
supersport.jpg&s2_2_xPos=121&s2_2_yPos=105&s2_2_xscale=100&s2_2_ys”;
_text[6]=“cale=100&s2_2_width=300&s2_2_height=238&s2_2_depth=2&s2_2_alpha=100&s2_2_c
redits=www.webbikeworld.com&on3=2&s3_0_duration=3427&s3_1_oType=headline&s3_1_type=s
Dir&s3_1_url=./Objects/Headlines/International/Headline.swf&s3_1_xPos=85&s3_1_yPos=55&s3_{—}
1_xscale=”;
_text[7]=“100&s3_1_yscale=100&s3_1_width=350&s3_1_height=50&s3_1_depth=1&s3_1_text=S
econd
Slide&s3_1_font=Arial&s3_1_fsize=24&s3_1_fcolor=3355443&s3_1_alpha=100&s3_2_oType=ima
ge&s3_2_name=User
Image&s3_2_type=wDir&s3_2_url=http://content.answers.com/main/content/wp/”;
_text[8]=“en/b/b1/Motorcycle_racing.jpg&s3_2_xPos=117&s3_2_yPos=107&s3_2_xscale=54&s3_{—}
2_yscale=54&s3_2_width=345.6&s3_2_height=230.6&s3_2_depth=2&s3_2_alpha=100&s3_2_cre
dits=content.answers.com&on4=2&s4_0_duration=3661&s4_1_oType=headline&s4_1_type=sDir&
s4_1_url=./O”;
_text[9]=“bjects/Headlines/International/Headline.swf&s4_1_xPos=85&s4_1_yPos=55&s4_1_xscal
e=100&s4_1_yscale=100&s4_1_width=350&s4_1_height=50&s4_1_depth=1&s4_1_text=Third
Slide&s4_1_font=Arial&s4_1_fsize=24&s4_1_fcolor=3355443&s4_1_alpha=100&s4_2_oType=ima
ge&s4_2_na”;
_text[10]=“me=User
Image&s4_2_type=wDir&s4_2_url=http://www.superbikeplanet.com/image/2006/mgp/USGP/tim03/
p07.jpg&s4_2_xPos=226&s4_2_yPos=45&s4_2_xscale=36&s4_2_yscale=36&s4_2_width=324&s
4_2_height=234&s4_2_depth=2&s4_2_alpha=100&s4_2_credits=www.superbikeplanet.com&”;
_text[11]=“eof=1&”;
sendText = “;
for (var i=0; i<12; i++) { sendText = sendText + _text[i]};
sDir = “;
document.forms[‘form’].sendText.value=sendText;
document.forms[‘form’].sDir.value=sDir;
document.forms[‘form’].submit( );
}
-->
</script>
</head>
<body onLoad=‘submitForm( );’>
<form action=‘https://www.spresent.com/presenter/simPView.php’ method=‘post’ name=‘form’>

<input name=‘sDir’ type=‘hidden’ />
<input name=‘sendText’ type=‘hidden’ />

</form>
</body></html>

1. A computer user interface for synchronizing an individual audio file and a plurality of slides in a presentation, the computer user interface comprising:
a timeline of the slides;
a plurality of identified markers, one marker for each of the plurality of slides, said plurality of identified markers user positionable with respect to said slide timeline; and
a timeline of the individual audio file located adjacent said slide timeline.

2. The computer user interface of claim 1, wherein said slide and audio timelines are linear.

3. The computer user interface of claim 2, wherein said slide and audio timelines are horizontal.

4. The computer user interface of claim 1, wherein said slide and audio timelines are the same length and have individual time scale factors.

5. The computer user interface of claim 1, wherein said markers can be dragged along said slide timeline.

6. The computer user interface of claim 1, wherein the time spacing between adjacent markers can be entered manually.

7. The computer user interface of claim 1, wherein said audio timeline includes a play button to initiate playback of the audio file to which the slides are being synchronized.

8. The computer user interface of claim 7, wherein an indicator progresses along both said slide and audio timelines as audio playback progresses.

9. A computer-readable medium or media having computer-executable instructions for presenting the computer user interface recited in any one of claims 1-8.
